(19) United States
(12) Patent Application Publication
(10) Pub. No.: US 2005/0008740 A1
(43) Pub. Date: Jan. 13, 2005

(54) Arrangement and method for treatment of a pumpable substance

(76) Inventor: Martin Lindgren, Goteborg (SE)

Correspondence Address: Steven S. Payne, 8027 ILIFF Dr., Dunn Loring, VA, 22027, US

(21) Appl. No.: 10/861,399

(22) Filed: Jun. 7, 2004

(30) Foreign Application Priority Data
Dec. 19, 2001 (SE) 0104289-4

(51) Int. Cl. C12H 1/06

(52) U.S. Cl. 426/244

(57) ABSTRACT

A method for continuous treatment of a pumpable substance with an electric field is disclosed. The substance is guided into the electric field. The substance is then exposed to the electric field. The substance is guided out of the electric field. The pumpable substance is separated into at least one defined volume, which volume is moved while it is exposed to the electric field. The invention also relates to an arrangement for implementing the method.

### TECHNICAL FIELD

The application relates to a method for continuous treatment of a pumpable substance with an electric field and also an arrangement intended for the treatment, which arrangement comprises a container in which the pumpable substance can be accommodated and a source for generating the electric field.

### BACKGROUND ART

Substances can be treated with electric fields in order to achieve various results. One of these is to render microorganisms present in the substance inactive. This technique is applied to food, for example, in order to extend the shelf life of the food.

In order to extend the shelf life of food, it is conventionally heated to high temperatures for a short time. The microorganisms in the food are rendered inactive, and in this way the shelf life of the food is extended.

However, high-temperature treatment of food often results In a change in taste of the food. This is due to the fact that not only are microorganisms rendered inactive, but flavourings are also modified by the high temperature. Other substances contained in the food, such as colouring agents, can also be modified by high-temperature treatment.

A need has therefore existed for a treatment which renders microorganisms inactive without denaturing one or more substances contained in the food.

WO 99/49561 describes a device for generating a pulsating electric field. This device can be used for inter alia non-thermal treatment of food for the purpose of extending the shelf life. The treatment is carried out in a chamber.

One disadvantage of a device according to the specification mentioned above is that the treatment of the substance is effected batchwise in a chamber. Such a device is not suitable for industrial use.

U.S. Pat. No. 4,695,472 describes a device for continuous treatment of liquid foods, such as juice, eggs or milk products, with pulsating electric fields. The food is treated with an electric field while it is conveyed through a container surrounded by electrodes. This device functions well with regard to the quantity of substance which can be treated continuously, as is necessary in an industrial process.

A device for continuous treatment with electric fields as above nevertheless results in great uncertainty with regard to the magnitude of the field strength to which a portion of a substance has been exposed or the length of time the action has continued. Since a flow of a substance through a container such as that described above demonstrates great differences in speed depending on whether a portion of the substance is located in the centre of the flow or close to the walls of the container, it is not possible to predict the field strength to which a portion of substance has been exposed or how long the action has continued.

There is therefore a need for a continuous treatment of substances with electric fields, which treatment includes a reproducibility with regard to the field strength to which the substance has been exposed and how long this action has continued.

### DISCLOSURE OF INVENTION

The above problem is solved by the invention by means of a method which comprises the steps of the pumpable substance being separated into at least one defined volume, which volume is moved while it is exposed to the electric field, and also an arrangement in which the container comprises at least one space separated from the rest of the container, in which space the pumpable substance can be accommodated and in which it can be exposed to the electric field.

By providing a method where the pumpable substance is enclosed in defined volumes, which volumes are moved while they are exposed to an electric field, the problems associated with batchwise treatment with electric fields are solved. By virtue of the fact that the volumes move during treatment, it is possible to apply the process industrially. The problems associated with previously known continuous treatments are also solved by the invention. By virtue of the substance being exposed to the electric field in separated volumes, a continuous process is obtained, without the particles in the separated volumes moving in relation to one another. In this way, all particles will be exposed to the electric field for the same length of time. In a continuous treatment chamber without separated volumes, this would not be the case. The pumpable substance would flow turbulently, and the throughput time for particles in the centre of the flow would be shorter than the throughput time for particles on the fringes of the flow.

Knowing the field strength to which each particle in a pumpable substance is exposed and how long this action continues is important in several respects. As far as the elimination of microorganisms in food is concerned, it is of utmost importance to know that the microorganisms it is intended to render inactive are rendered inactive. Different microorganisms have different resistance to the field strength supplied. In the event of it being desirable to render some types of microorganism inactive while others are kept active, there is also a corresponding desire for control over the process. Rendering microorganisms inactive by applying an electric field takes place by the cell membrane in the microorganisms being destroyed. This process is determined by the strength of the electric field and the length of time for which the field is applied. These parameters vary with the type of microorganism it is desired to render inactive.

In one embodiment of the invention, the separated space consists of all or part of the positive displacement in a pump. Pumps which meet the above criteria are suitable for this purpose. Examples of suitable pumps are lobe rotor pumps and gear pumps. The advantage of incorporating the separated space into a pump is that a pump action on the whole of the pumpable substance is also obtained. However, within the scope of the invention, the separated spaces can be constructed separately from a pump which drives a continuous process. The pump can even be omitted completely in a case where, for example, gravity is used for conveying the pumpable substance and the separated volumes.

According to a preferred embodiment of the invention, the arrangement is arranged so that the separated space has a cylindrical shape. A cylindrical shape means a shape which is delimited by two planes which have the same geometry and are connected at every point by a great many lines orthogonal to the planes. These planes can have, for example, square or circular or other suitable shape.

By arranging the separated space in the form of a cylindrical shape where the planes which delimit the cylinder consist of electrodes and the walls which connect the two planes consist of insulators, a uniform field strength is obtained over the entire volume of pumpable substance accommodated therein. With such a construction, the disturbance of the electric field which other designs could bring about does not occur.

A cylindrical design of the separated spaces is preferred. However, other designs of the separated space are included within the scope of the invention. The effect on the distribution of the field strength which is obtained with a number of other constructions is moderate. It is also possible to influence a disadvantageous shape by modifying the relative dimensions of length, width and height.

### DESCRIPTION OF FIGURES

FIG. 1 shows diagrammatically an embodiment of the invention.

FIG. 2 shows a diagram of the field strength in a device according to the prior art.

FIG. 3 shows a diagram of the field strength in a device according to the prior art.

### DETAILED DESCRIPTION OF THE INVENTION

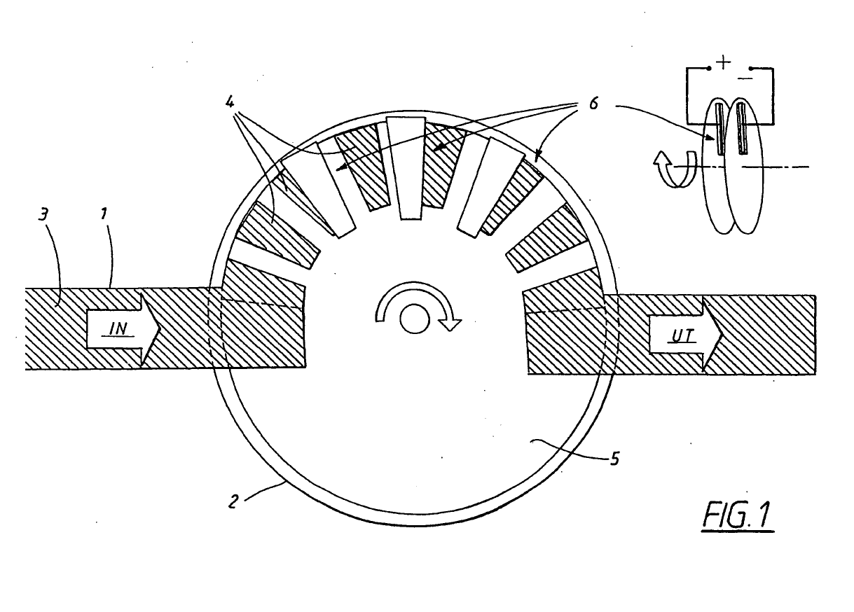

FIG. 1 shows a diagrammatic illustration of an arrangement according to an embodiment of the invention. The arrangement comprises a container 1 for conveying a pumpable substance. A pump 2 is present as a part of the container. The pump can be, for example, a lobe rotor pump or a gear pump. The pump 2 conveys the pumpable substance 3 through the container 1. Moreover, the pump 2 provides the arrangement with separated spaces 4 in which the substance 3 can be exposed to an electric field. The separated spaces 4 are located in the pump housing 5 of the pump 2 and, in this embodiment, consist of the spaces in the pump housing 5 which convey the pumpable substance 3 through the pump 2. In a preferred embodiment, the electric field is pulsed and arranged so that a voltage is applied only during the time for which each chamber in the pump forms a separated space 4, which means that the chamber has been closed after contact with the inlet of the pump and has not yet opened to the outlet. The pulse or pulses is or are preferably of such a nature that the electric field is applied for only a fraction of the time consumed for conveying the separated spaces between the inlet duct and the outlet duct. According to an illustrative embodiment, the pulses are applied for one to ten microseconds. The pulsation can be brought about by the pump being provided with trailing contacts which bring about contacting for the electrodes when the rotor included in the pump is located in given positional intervals. According to an alternative embodiment, the pulsation can be brought about by the pump being provided with a position sensor and the voltage source being provided with trigger points for application of voltage between these trigger points.

According to an alternative embodiment, the source for generating the electric field 6 is arranged so as continuously to generate an electric field. According to this embodiment, the field can, depending on the positioning of the electrode, also be applied during the phase in which the chambers of the pump are opened to the inlet duct and outlet duct, that is to say before and, respectively, after the separated spaces 4 have been formed. This embodiment results in the flow being exposed partially to edge effects on account of inhomogeneous fields in the opening to the inlet duct or the outlet duct. Furthermore, a complicated flow process is obtained when inflow takes place to the pump space which forms a separated space 4 and when outflow takes place after a separated space has been opened to the outlet duct. In spite of these disadvantages in relation to the preferred embodiment, a more homogeneous treatment result is obtained than with conventional continuous technology because the majority of the energy applied is applied in controlled forms when the flowing medium is located in the separated spaces 4. This embodiment has the advantage that it is less expensive to construct than the embodiments described above with pulsed fields and can be used when a lower degree of homogeneity of the energy quantity applied to the flowing medium is required.

Arranged around the separated spaces 4 are three pairs of electrodes 6. These constitute the source for generating the electric field. Each of the electrode pairs surrounds a respective separated space. The electrode pairs are arranged with the positive electrode on one side of a separated space 4 and the negative electrode on the other side of the space 4, each electrode pair therefore surrounding, at some time, a respective separated space. It is of course possible within the scope of the invention to vary the number of spaces 4 and electrode pairs. The electrode pairs generate an electric field in the separated spaces 4.

The separated spaces 4 are rotated and translated in the pump housing 5 so that the pumpable substance 3 accommodated in the separated spaces 4 is moved in the direction in which the rest of the pumpable substance 3 accommodated in the remaining part of the container 1 is moved. This takes place, however, without the separated volumes of the substance moving in relation to the spaces 4 in which they are accommodated. In this way, a continuous process is obtained without the particles in the separated volumes which are to be treated in the separated spaces moving in relation to one another. All particles will in this way be exposed to the electric field for the same length of time. In a continuous treatment chamber without separated spaces, this would not be the case. The pumpable substance would flow turbulently, and the throughput time for particles in the centre of the flow would be shorter than the throughput time for particles on the fringes of the flow.

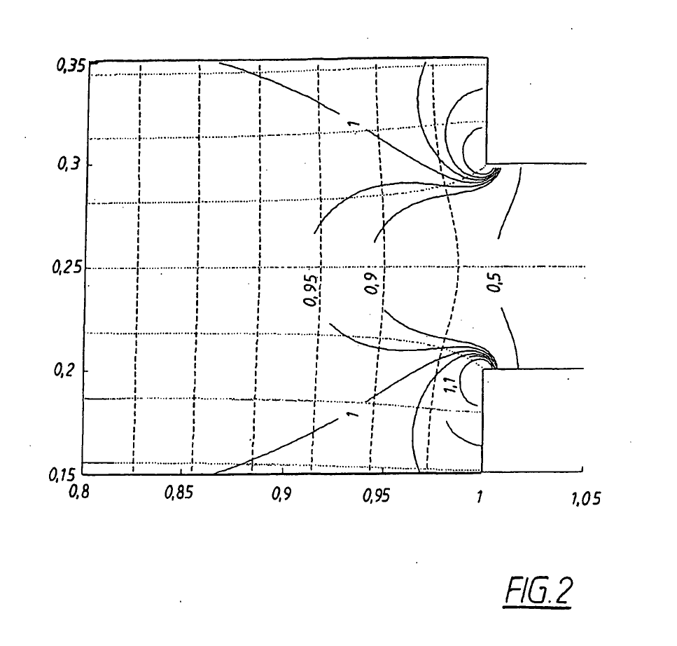

By virtue of the spaces 4 being separated, there is no inlet or outlet for the time during which the treatment in the electric field takes place, and the disturbed electric fields which inlet and outlet would generate are avoided. FIG. 2 shows an example of how the electric field appears around an outlet in a continuous treatment chamber according to the state of the art. The electrodes are located at the top and at the bottom in the figure. The walls of the outlet constitute insulators. FIG. 2 shows how the electric field is distorted in the area round the outlet. It is difficult to predict the field strength to which each particle in the pumpable substance has been exposed. By means of the invention, this effect is therefore avoided.

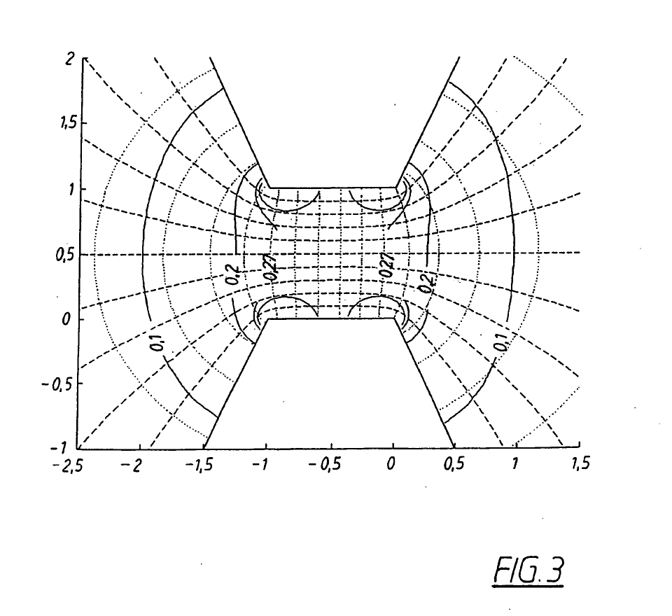

The separated spaces 4 according to the embodiment are in the form of cylinders. The two electrodes 6 in each electrode pair constitute the base surfaces in the cylinder. In this embodiment, the arrangement has three electrode pairs. It is of course possible within the scope of the invention to have other numbers of electrode pairs such as, for example, two. By means of this construction, a uniform field strength is obtained over the entire spaces 4. This can be contrasted with a continuous process according to, for example, FIG. 4 in U.S. Pat. No. 4,695,472 mentioned previously. This device has a number of electrodes arranged along a continuous container. The electrodes are separated in the travel direction by projecting insulators. This construction gives rise to a distorted electric field. This is illustrated in FIG. 3 in the present application. The electrodes are located in the upper and lower part of the figure. Two electrode pairs are shown here. The two electrode pairs are separated by two projecting insulators.

What is described above is a device comprising electrodes which are stationary in relation to the spaces in which the substance is located. It is also possible within the scope of the invention to make use of movable electrodes.

The embodiments of the invention shown represent only examples of how the invention can be implemented, and the invention is not limited by these.

1-8 (cancelled).

9. A method for continuous treatment of a pumpable substance with an electric field, comprising the steps of:
guiding the substance into the electric field;
exposing the substance to an electric field;
guiding the substance out of the electric field, wherein the pumpable substance is separated into at least one separated volume which is moved while it is exposed to the electric field.

10. The method according to claim 9, wherein the pumpable substance is moved by a pump, and the separated volume is accommodated in a space which consists of all or part of the displacement of the pump.

11. The method according to claim 9, wherein the separated volume has a cylindrical shape.

12. The method according to claim 9, wherein the electric field consists of a pulsed electric field.

13. An arrangement for treatment of a pumable substance with an electric field, comprising a container in which the pumpable substance can be accommodated, and a source for generating the electric field, wherein the container comprises at least one space separated from the rest of the container, in which space the pumpable substance can be accommodated and in which the pumable substance can be exposed to the electric field.

14. The arrangement according to claim 13, further comprising a pump and the separated space consists of a pump housing chamber.

15. The arrangement according to claim 13, wherein the separated space has a cylindrical shape.

16. The arrangement according to claim 13, wherein the source for generating the electric field is arranged so as to generate a pulsating electric field.
